(19) United States
(12) Patent Application Publication
(10) Pub. No.: US 2024/0320030 A1
(43) Pub. Date: Sep. 26, 2024

(54) TRANSACTIONS IN PROCESSING ENVIRONMENTS

(71) Applicant: International Business Machines Corporation, Armonk, NY (US)

(72) Inventors: Andrew Wright, Eastleigh (GB); James Anthony Harrison, Loughborough (GB); Mark William Trafford Todd, Lincoln (GB); William Anthony Fitzgerald, Solihull (GB); Paulo Roberto Pontin Tiziano, Sofia (BG); Mark Andrew Woolley, Winchester (GB); Philip I Wakelin, Eastleigh (GB); Stephen James Hobson, Hampton (GB); Philip Robert Lee, Hants (GB); Jenny Jing He, Chandler's Ford (GB)

(21) Appl. No.: 18/331,967

(22) Filed: Jun. 9, 2023

(30) Foreign Application Priority Data
Mar. 23, 2023 (GB) 2304225.2

(51) Int. Cl. G06F 9/46

(52) U.S. Cl. CPC G06F 9/467

(57) ABSTRACT

A determination is made whether a requested transaction of a certain type or class is available (i.e., suitable for execution or queueing) within a processing environment. In the case that a transaction of the certain type or class is not available, the request to be rejected is enabled, thus avoiding queuing of the requested transaction. Embodiments may thus provide a mechanism to protect a processing environment by avoiding the overhead of creating and removing specific transactions of the certain type or class.

### BACKGROUND

A system and method disclosed herein generally relates to the field of data processing environments, and more particularly, to managing workload (e.g., executing and queued transactions) of a processing environment (such as a transaction processing environment).

In a transaction processing environment, work is initiated from external regions (“producers”) and handled by regions that create transactions to manage it (“listeners”). A transaction processing environment may be configured (e.g., by customers) to limit the number of transactions that can coexist within the environment at any one time (e.g., a ‘MAXTASK’ limit), and may also be configured to limit the number of instances of individual transaction type or class (e.g., a ‘MAXACTIVE’ limit).

For example, a transaction of a particular class may be capped to only allow one instance of a transaction of that class to be present within a processing environment at a time (e.g., “MAXACTIVE=1” for the class of transactions). Further instances of transactions of the class that are initiated will then either be queued by pending completion of existing instance(s) to complete, or purged when a predefined limiting threshold for this queuing is reached (e.g., “PURGETHRESH=x” for the class of transactions). Such purged transactions are initiated and then abended, thus using system resource(s).

Processing environments may thus suffer from additional performance degradation due to the internal processing that has to accompany the abending of transactions. This is a widely-known issue, typically experienced when a processing environment is stressed. Indeed, there may be a significant transactional overhead that has to take place today before the deferred abend condition can be detected and honored. For instance, a processing environment has to initialize the new transaction, allocate the system resources for it, then dispatch the transaction and have it progress through the transaction initialization and bind stages for the many transaction manager clients. Only when the stage has been reached where the deferred abend can be honored does the processing environment initiate the abend processing for the newly created transaction. Accordingly, the conventional mechanism of abending new instances of transactions is problematic for processing environments running close to their operational limits.

For instance, if a processing environment is already constrained due to MAXTASK throttling (for all transactions) and MAXACTIVE throttling (for a given class of transaction), and is running with a high CPU utilization, then the additional overhead of having to create, attach, dispatch, and abend transactions for instances of new work that is to be abended makes the situation worse, thus compounding a performance impact to a user/customer.

### SUMMARY

Various embodiments of the present invention seek to provide one or more concepts for handling a request for a transaction of a particular type or class in a processing environment. Such concepts may be computer-implemented. That is, such methods may be implemented in a computer infrastructure having computer executable code tangibly embodied on a computer readable storage medium having programming instructions configured to perform a proposed method. Various embodiments of the present invention further seeks to provide a computer program product including computer program code for implementing the proposed concepts when executed on a processor. Various embodiments of the present invention yet further seeks to provide a system handling a request for a transaction of a particular type or class in a processing environment.

According to an aspect of the present invention there is provided a computer-implemented method for determining availability of a transaction in a processing environment. The method comprises determining a count value of the number of transactions of a class of transactions existing within the processing environment. The method also comprises determining if the count value meets a first predetermined requirement. A value of an availability indicator for the class is then set based on the determining the count value meets the first predetermined requirement.

According to another aspect of the present invention, there is provided a computer-implemented method for handling an inbound request for a transaction in a processing environment, the method comprising: receiving a request for a transaction in the processing environment, the transaction belonging to a class of transactions; determining availability of a transaction of the class in the processing environment according to a proposed embodiment; and determining a handling action for the received request based on the value of the availability indicator for the class.

Thus, there may be provided an approach to determining whether a requested transaction of a certain type or class is available (i.e., is suitable for execution or queueing) within a processing environment. In the case that a transaction of the certain type or class is not available, the proposed approach enables the request to be rejected, thus avoiding queuing of the requested transaction.

Put another way, the various embodiments of the invention seek to provide one or more concepts for preventing the execution or queuing of a requested transaction type/class in a processing environment when it is preferable to not add transactions of that type/class to the workload of the processing environment. Proposed embodiments may thus provide a mechanism to protect a processing environment by avoiding the overhead of creating and removing specific transactions of the certain type/class, by temporarily rejecting classes of request when an undesirable operating condition is met, and by accepting classes of request when the undesirable operating condition is not met. This may, for example, employ a flexible model with an instantaneous count of in-flight requests. Other exemplary embodiments may employ a smoothed count of in-flight requests, thereby regulating the queuing of new requests by predicting a likelihood of the request being accepted for processing (e.g., as governed by the performance of the processing environment).

Proposed embodiments may thus provide one or more concepts for improving system resilience and reducing resource contention when handling peaks or spikes of workload initiation. In particular, embodiments may provide a mechanism for avoiding abending new work when a class of transactions reaches a threshold limit for queuing new instances of transactions.

In addition, embodiments of the present invention provide concepts for a non-transitory computer readable medium comprising code stored thereon that, when executed, performs a method for determining availability of a transaction in a processing environment, the transaction belonging to a class of transactions, the method comprising: determining a count value of the number of transactions of the class existing within the processing environment; determining if the count value meets a first predetermined requirement; and setting the value of an availability indicator for the class based on whether or not the count value is determined to meet the first predetermined requirement.

Embodiments may be employed in combination with conventional/existing processing environments, such as transaction processing environments for example. In this way, embodiments may integrate into legacy systems so as to improve and/or extend their functionality and capabilities. An improved processing environment may therefore be provided by proposed embodiments.

According to another aspect, there is provided a system comprising: one or more processors; and a memory comprising code stored thereon that, when executed, performs a method for determining availability of a transaction in a processing environment, the transaction belonging to a class of transactions, the method comprising: determining a count value of the number of transactions of the class existing within the processing environment; determining if the count value meets a first predetermined requirement; and setting the value of an availability indicator for the class based on whether or not the count value is determined to meet the first predetermined requirement.

Thus, there may be proposed concepts for handling a request for a transaction of a certain type/class in a processing environment, wherein the concepts provide one or more approaches to determining availability of a transaction of that type within the processing environment (e.g., a number of active and queued transactions of the type/class present within the processing environment does not exceed a predetermined threshold value).

### BRIEF DESCRIPTION OF THE DRAWINGS

Embodiments of the invention will now be described, by way of example only, with reference to the accompanying drawings in which:

FIG. 1 depicts a computing node according to an embodiment of the present invention.

FIG. 2 depicts an illustrative computing environment according to embodiments of the present invention.

FIG. 3 illustrates a method for determining availability of a transaction in a processing environment according to an embodiment; and

FIG. 4 depicts a method for handling an inbound request for a transaction in a processing environment according to an embodiment, wherein the method employs the method of FIG. 3.

### DETAILED DESCRIPTION

The Figures are merely schematic and are not drawn to scale. The same reference numerals are used throughout the Figures to indicate the same or similar parts.

A method, as defined herein is a process for execution by a computer, i.e., is a computer-implementable method. The various operations of the method therefore reflect various parts of a computer program, e.g., various parts of one or more algorithms.

A system may be a single device or a collection of distributed devices that are adapted to execute one or more embodiments of the methods of the present invention. For instance, a system may be a personal computer (PC), a portable computing device (such as a tablet computer, laptop, smartphone, etc.), a set-top box, a server, or a collection of PCs and/or servers connected via a network, such as a local area network, the Internet, and so on to cooperatively execute at least one embodiment of the methods of the present invention.

The technical character of the present invention generally relates the field of processing environments, and more particularly, to managing workload (e.g., executing and queued transactions) of a processing environment (such as a transaction processing environment). More specifically, embodiments of the present invention provide concepts for handling requests for transactions of a particular type or class in a processing environment.

Firstly, there is provided a method for determining availability of a transaction in a processing environment, the transaction belonging to a class of transactions. The method comprises determining a count value of the number of transactions of the class existing within the processing environment. The method also comprises determining if the count value meets a first predetermined requirement. A value of an availability indicator for the class is then set based on whether or not the count value is determined to meet the first predetermined requirement.

Then, leveraging the method of the preceding paragraph, there may also be provided a method for handling an inbound request for a transaction in a processing environment, wherein the method comprises: receiving a request for a transaction in the processing environment, the received request belonging to a class of transactions; determining availability of a transaction of the class in the processing environment according to the method of the preceding paragraph; and determining a handling action for the received request based on the value of the availability indicator for the class.

Thus, there are proposed concepts for determining whether a requested transaction of a certain type or class is available (i.e., suitable for execution or queueing) within a processing environment. In the case that a transaction of the certain type or class is not available, the proposed concept may enable the request to be rejected, thus avoiding queuing of the requested transaction. Embodiments may thus provide a mechanism to protect a processing environment by avoiding the overhead of creating and removing specific transactions of the certain type or class.

Accordingly, proposed is a concept for regulating the inbound flow of requests to computer systems (such as a transaction processing platform). However, although described in relation to transaction processing environments, embodiments may be applied to other processing environments.

Purely by way of initial summary, embodiments may comprise the following characteristics:

Embodiments are primarily intended for use in a processing environment where there are several options for handling inbound requests, for example: (i) a request can be accepted and scheduled for immediate processing; (ii) a request can be accepted and queued for later processing; (iii) a request can be accepted and queued for cancellation; and (iv) a request can be rejected immediately. Such differing actions may be preferred depending on, for example: (a) how busy the system is with requests that are already processing; (b) how many requests are already queued for processing; (c) characteristics of the new request, such as its priority, the amount and type of resources it requires, etc.

Compared with existing mechanisms, an embodiment according to the proposed invention may provide several advantages, such as the following:
(i) enables avoiding the overhead of creating and discarding state representing requests that are to be rejected, typically when a system is already busy;
(ii) by employing a ‘smoothed’ or ‘averaged’ count of transactions, it can be tuned to queue requests during short “spikes” but to cancel or discard requests in longer “overload” conditions; and
(iii) processing overhead is low (e.g., relatively low number of processor instructions per request), as it decouples the relatively complex decision-making process of whether or not to allow requests from the logic which needs to decide what action to take.

That is, proposed is an alternative approach to abending new instances of transactions after a predetermined condition is reached (such as the instantaneous or smoothed number of transaction requests of a class exceeds MAXACTIVE+PURGETHRESH). That is, the approach removes the concept of creating new instances of transactions and abending them when PURGETHRESH is met for the queue.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

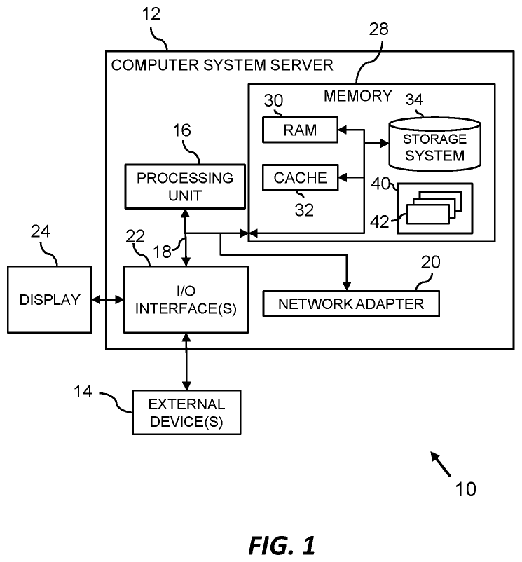

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment.

Program modules 42 generally carry out the functions and/or methodologies of embodiments of the invention as described herein. For example, some or all of the functions of a DHCP client 80 can be implemented as one or more of the program modules 42. Additionally, the DHCP client 80 may be implemented as separate dedicated processors or a single or several processors to provide the functionality described herein. In embodiments, the DHCP client 80 performs one or more of the processes described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID (redundant array of inexpensive disks or redundant array of independent disks) systems, tape drives, and data archival storage systems, etc.

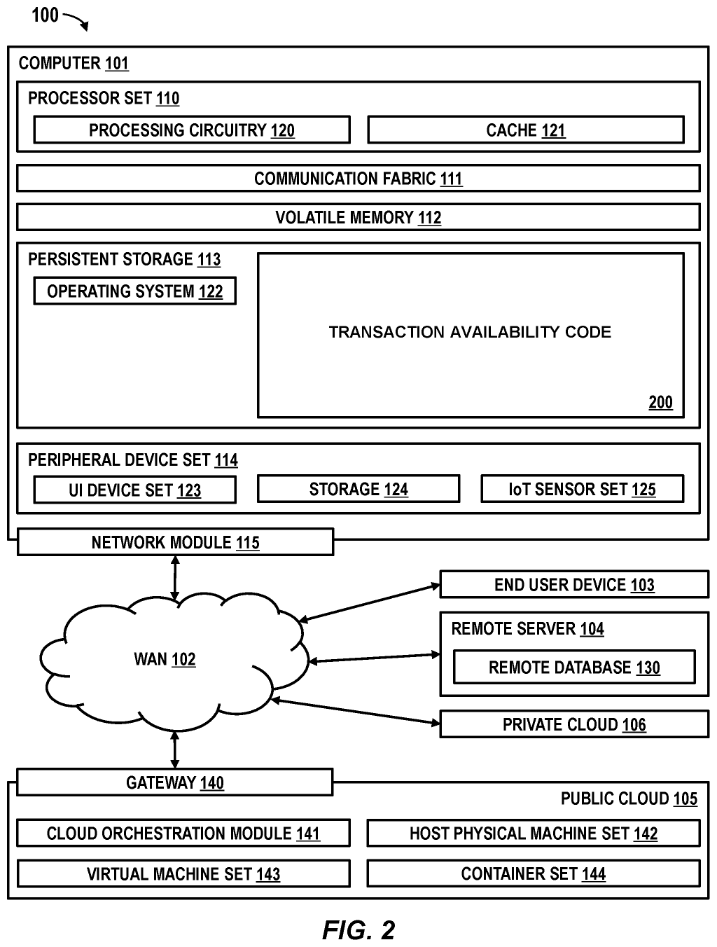

Referring now to FIG. 2, an illustrative computing environment 100 is depicted. A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a proposed method for determining availability of a transaction in a processing environment (i.e., transaction availability code) 200, wherein the transaction belongs to a class of transactions. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operations to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

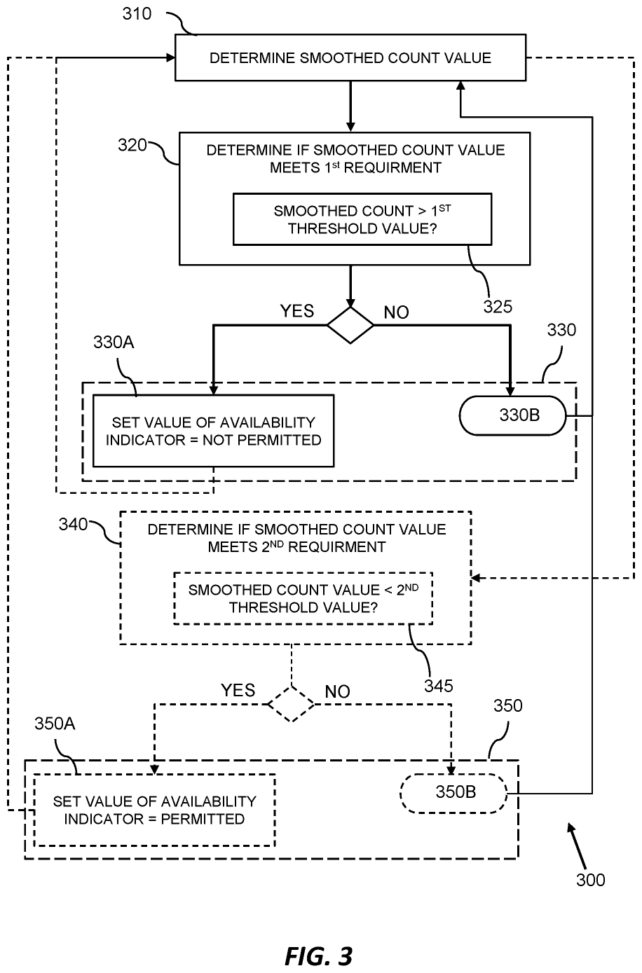

Referring now to FIG. 3, there is depicted a flow diagram of a computer-implemented method 300 for determining availability of a transaction in a processing environment, specifically a transaction processing environment. Here, the transaction belongs to a class of transactions (e.g., transaction class ‘A’, or ‘TransClassA’) That is, the transaction is a particular type or class of transaction, such that it belongs to a specific, predetermined class of transaction (TransClassA).

The method begins with the operation 310 of determining a smoothed count value of the number of transactions of the class existing within the processing environment. Here, determining a smoothed count value of the number of transactions of the class TransClassA existing within the processing environment comprises calculating the smoothed number of active and queued transactions of the class TransClassA present within the processing environment.

Many different calculation algorithms or techniques may be employed to calculate such a smoothed count value. Example techniques include the following:

Moving Average: This technique involves calculating the average of a specified number of neighboring counts. For example, a seven-transaction moving average would calculate the average count value over the previous seven transactions. The moving average technique can help smooth out short-term fluctuations and provide a better picture of the overall trend.

Exponential Smoothing: This technique uses a weighted average that gives more weight to more recent count values. The weight decreases exponentially as the count value gets older. This technique may be used to forecast future count values.

LOESS: Locally Weighted Scatterplot Smoothing (LOESS) is a non-parametric regression technique that fits a smooth curve to the count data using a weighted average of neighboring counts. This may be useful when the data has complex patterns and non-linear relationships.

Gaussian Kernel Density Estimation: This technique estimates the probability density function of the count data by smoothing out the data using a Gaussian kernel. The resulting smooth curve can provide insights into the distribution of the count values.

Splines: This technique involves fitting a piecewise polynomial function to the count data, with the goal of minimizing the overall curvature of the function. Splines can be used to capture complex patterns in the data while still providing a smooth representation of the count values.

Such techniques may be used individually or in combination to calculate a smooth count value.

Next, operation 320 comprises determining if the calculated smoothed count value meets a first predetermined requirement. More specifically, in this exemplary embodiment, the first predetermined requirement requires the smoothed count value to be greater than a first threshold value. For example, in this embodiment, the threshold value is greater than a maximum number of active transactions of the class TransClassA permitted within the processing environment (e.g., the 1^{st} threshold value>MAXACTIVE for the class TransClassA). More specifically the 1^{st} threshold value equals MAXACTIVE+PURGETHRESH Operation 320 thus comprises the operation 325 of determining if the smooth count value is greater than the first threshold value.

The method then proceeds to operation 330 of setting the value of an availability indicator for the class TransClassA based on whether or not the smoothed count value is determined to meet the first predetermined requirement. More specifically, setting the value of the availability indicator for the class TransClassA comprises: (i) responsive to determining that the smoothed count value meets the first predetermined requirement, setting 330A the value of the availability indicator to indicate that a transaction of the class TransClassA is not permitted within the processing environment; and (ii) responsive to determining that the smoothed count value does not meet the first predetermined requirement, setting 330B nothing (i.e., not changing the value of the availability indicator) and then returning to operation 310.

Furthermore, after undertaking operation 330A, the method may subsequently calculate a new smoothed count value (e.g., after a predetermined time period has elapsed, or after the processing system has accepted or completed work for a class.). This may then be used to determine if and when the value of the availability indicator may be changed back to indicate that a transaction of the class TransClassA is permitted once again. This concept (of subsequently checking and reverting the availably indicator back to indicating permission for transactions of the class TransClassA) is illustrated in FIG. 3 using dashed arrow and boxes.

Thus, after undertaking operation 330A, the method may return to operation 310 to calculate a new, updated smoothed count value, and then subsequently proceed to 340.

Operation 340 comprises determining if the new/updated smoothed count value meets a second predetermined requirement. More specifically, the second predetermined requirement requires the new, updated smoothed count value to be less than a second threshold value. In this embodiment, the second threshold value is less than the first threshold value, i.e., less than the maximum number of active transactions of the class TransClassA permitted within the processing environment (e.g., the 2^{nd} threshold value<MAXACTIVE for the class TransClassA). Operation 340 comprises the operation 345 of determining if the smooth count value is less than the second threshold value.

The method then proceeds to the operation 350 of setting the value of the availability indicator for the class TransClassA based on whether or not the new, updated smoothed count value is determined to meet the second predetermined requirement. More specifically, setting the value of the availability indicator for the class TransClassA comprises: (i) responsive to determining that the new smoothed count value meets the second predetermined requirement, setting (350A) the value of the availability indicator to indicate that a transaction of the class TransClassA is permitted within the processing environment; and (ii) responsive to determining that the new smoothed count value does not meet the second predetermined requirement, setting 350B nothing (i.e., not changing the value of the availability indicator) and then returning to operation 310.

From the above description, it will be appreciated that the example method of FIG. 3 may be employed to determine availability of a transaction of a specific class (e.g., TransClassA) in a processing environment. The determined availability is indicated by a value of an availability indicator set/defined by the method. The method may therefore be repeatedly executed to continually update the availability indicator (e.g., periodically or every time a request for a transaction of the class is received).

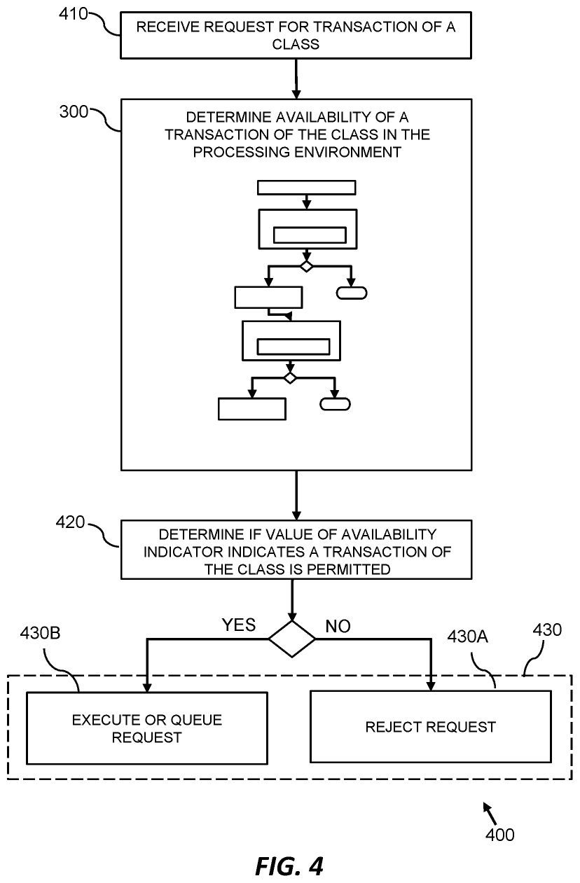

By leveraging the above-described method, embodiments may also provide a computer-implemented method for handling an inbound request for a transaction in a processing environment. By way of example, a simplified embodiment of method for handling an inbound request for a transaction in a processing environment will now be described with reference to FIG. 4.

FIG. 4 is a flow diagram of a method 400 for handling an inbound request for a transaction in a processing environment according to a proposed embodiment, wherein the method employs the method 300 of FIG. 3. Again, the transaction belongs to the specific class of transactions TransClassA referred to in the embodiment of FIG. 3.

The method 400 begins with the operation 410 of receiving a request for a transaction in the processing environment, wherein the requested transaction belonging to the class TransClassA of transactions.

The method then proceeds to execute the method 300 of determining availability of a transaction of the class TransClassA in the processing environment. Execution of the method 300 results in the value of the availability indicated being set/defined so as to indicate whether or not a transaction of the class TransClassA is permitted within the processing environment.

Next, in operation 420, it is determined if the value of the availability indicator for the class TransClassA indicates a transaction of the class TransClassA is permitted. That is, operation 420 comprises determining the value of the availability indicator for the class TransClassA.

The method then proceeds to operation 430 of determining a handling action for the received request is based on the value of the availability indicator for the class TransClassA. Specifically, determining a handling action for the received request comprises: (i) if the value of the availability indicator for the class TransClassA indicates that a transaction of the class TransClassA is not permitted, the handling action is determined 430A to comprise the action of rejecting the received request; and (ii) if the value of the availability indicator for the class TransClassA indicates that a transaction of the class TransClassA is permitted within the processing environment, the handling action is determined 430B to comprise the action of executing or queuing the received request.

From the above description, one or more concepts for a transaction processing system are provided that may avoid the overhead of creating specific classes of transaction instances. In particular, the concept(s) may temporarily reject classes of transaction using a hysteresis model with a smoothed count of in-flight requests to regulate the queuing of new requests.

In this way, various embodiments may queue a new work request when it is still relatively likely to complete as a transaction within an acceptable time, but may reject a work item when it is likely to abend due to excess queue time.

Further, the embodiments described above with reference to FIGS. 3 and 4 employ a smoothed count of transactions of a specific class. This may provide a changing count for the number of transactions of interest within a processing environment over a period of time. Purely by way of further example, one form of smoothing may employ a weighted average of the current observation and the previous smoothed statistic. However, other embodiments may not employ data smoothing techniques to determine and employ a smoothed count, but may instead employ an instantaneous count of transactions. That is, some embodiments may determine a count value describing an actual/exact number of transactions of the class existing within the processing environment at that moment. Such embodiments may provide the benefit of reduced computational requirements while still enabling the provision of an availability indicator that can be used to temporarily reject classes of transaction (and thus avoid the overhead of creating specific classes of transaction instances).

Also, embodiments may be adapted to maintain a record of the number of instances of the particular transaction class within the processing environment. This could, for example, be determined over each one second time interval. The actual “sampling rate” (i.e., rate of recalculating a count value) may vary and/or be adjustable, so as to modify the sampling sensitivity for example. That is, embodiments may be arranged to regularly update the count value to represent the workload of transactions for a specific transaction class.

Various embodiments of the invention may use the smoothed value to determine whether or not to start queuing new instances of the transactions in the transaction class (e.g., TransClassA), using this smoothed data as determined from previous calculations of the count.

Responding to a changing workload which might be a mix of brief spikes (for which queuing is a sensible response) and longer trends (for which purging excess work items is a sensible response) works better with smoothed values than with point-in-time values. Validating a smoothed transaction count may allow the processing environment to react to a spike by still queuing new transaction requests but react differently to a sustained increase in work by discarding new instances of the transactions.

For instance, if the smoothed count value for the transaction class TransClassA reached its MAXACTIVE value, new instances of transactions will still be queued as in conventional approached. However, if the transaction rate grew due to a longer term trend and not just a simpler spike of new work, then the smoothed count of transactions would at some point reach (and even exceed) the first threshold value. At this point, proposed embodiments may suppress new instances of work by setting the transaction class as “temporarily unavailable” (e.g., set the value of the availability indicator to indicate that a transaction of the class TransClassA is not permitted). A new instance of the transaction of class TransClassA would then be prevented from being created. This would prevent the transaction instance from being placed on a queue of instances of the transaction. That is, while the availability indicator indicates that a transaction of the class TransClassA is not permitted, work for the class TransClassA is rejected upfront with minimum resource impact to the processing environment.

In conventional approaches, a class's PURGETHRESH value specifies a well-defined upper queue size before new work is abended. With various embodiments of the present invention, however, this value may act as a trigger to prevent new transactions being instantiated when the smoothed transaction count value reaches MAXACTIVE+PURGETHRESH for example (i.e., the first threshold may be set to equal MAXACTIVE+PURGETHRESH). The processing environment may in fact allow more transactions to be queued on for the transaction class TransClassA than the PURGETHRESH value specifies, before a subsequent recalculation of the smoothed count reaches the MAXACTIVE+PURGETHRESH value and makes the TRANCLASS temporarily unavailable. In embodiments according to the present invention, the PURGETHRESH may therefore act as a trigger to reject new work, but is not a well-defined upper limit on how many new instances of a transaction may be queued on a TRANCLASS before new work gets rejected.

When the number of instances of the TransClassA transactions drop back to below the MAXACTIVE limit, embodiments of the invention may be adapted to determine this on a subsequent recalculation of the smoothed count value (e.g., using the second threshold value), and may then reset the availability indicator to indicates more work for the class TransClassA is available once more.

The setting and unsetting of an availability indicator for a transaction class may therefore be thought of as implementing a hysteretic property of the system, hysteresis being the dependence of the state of a processing environment on its history.

Purely by way of further description, a simplified example will now be described. The example details a series of sequential sampling periods to illustrate how the proposed concept(s) sets the available of a class of transactions as temporarily unavailable or not. In this example, the limits are as follows:

MAXACTIVE (for limiting number of active transactions)=100

PURGETHRESH (for limiting number of queued transactions)=50

Thus, the first threshold value=150

Table 1 below shows a series of sequential sampling periods and the respective values for the number of active transactions, queued transactions, total transactions, smooth count value and availability indicator.

TABLE 1

| | | | | Smoothed | |
|---|---|---|---|---|---|
| Sample | Active | Queued | Total | Count | TransClassA |
| # | Transactions | Transactions | Transactions | Value | Availability |
| 1 | 80 | 0 | 80 | 75 | TransClassA available |
| 2 | 95 | 0 | 95 | 85 | TransClassA available |
| 3 | 100 | 30 | 130 | 120 | TransClassA available |
| 4 | 100 | 50 | 150 | 145 | TransClassA available |
| 5 | 100 | 55 | 155 | 148 | TransClassA available |
| | | | | | (possible spike) |
| 6 | 100 | 40 | 140 | 145 | TransClassA available |
| | | | | | (spike passed) |
| 7 | 100 | 60 | 160 | 148 | TransClassA available |
| | | | | | (possible spike) |
| 8 | 100 | 65 | 165 | 160 | TransClassA |
| | | | | | unavailable (sustained |
| | | | | | work) |
| 9 | 100 | 30 | 130 | 150 | TransClassA |
| | | | | | unavailable while work |
| | | | | | drains |
| 10 | 100 | 0 | 100 | 120 | TransClassA |
| | | | | | unavailable while work |
| | | | | | drains |
| 11 | 90 | 0 | 90 | 95 | TransClassA available, |
| | | | | | new transactions |
| | | | | | allowed |

The example shows a scenario where an embodiment of the invention allows one sampling period to pass when the smoothed number has exceeded the first threshold value before setting the transaction class as unavailable. This caters for short-duration spikes in otherwise manageable workloads.

The above example uses PURGETHRESH to determine the number of queued transactions. The limit of queued transactions may be determined by the smoothed number of transactions minus the active number of transactions.

Accordingly, with the proposed approach(es), new transaction instances for the class will still be queued when MAXACTIVE is reached for the class TRANCLASS. However, the processing environment will not create and abend further new transaction instances when the PURGETHRESH value is reached. Instead, as the proposed approach recalculates the smoothed transaction count value, it will (if appropriate) set the TRANCLASS as temporarily unavailable (via the availability indicator for the transaction class). This means new instances of work for the transaction class will be rejected upfront with minimum resource impact to processing environment, and not be turned into transaction instances to be queued and abended.

Embodiments may therefore provide the benefit of avoid the conventional approach of new transactions being purged. That is, according to various embodiments of the invention, there will not be a physical instance of a transaction to be abended. However, embodiments may report the failure to create the new instance of the transaction (e.g., via standard features such as a message, response code to API caller, etc.).

By avoiding having to purge new transactions for a transaction class which has reached its PURGETHRESH, embodiments may remove the cost and/or overhead associated with such work, thus reducing impact on customer systems.

In summary, by using a smoothed count of in-flight work items to regulate queuing new work, various embodiments queue a new work item when it is still relatively likely to complete within an acceptable time, but reject the work item when it is less likely to. The various embodiments of the invention may therefore avoid the overhead of creating transaction instances and then abending them when new work is temporarily being rejected.

By way of summary, request handling approaches may comprise the following aspects:

Using a classification system to identify requests as being in different classes;

Continuously/repeatedly calculating the number of inflight and queued workload requests for a transaction class;

Setting the availability indicator for the transaction class by comparing a count of inflight and queued requests for the transaction class queue with a first threshold, and resetting the availability indicator when the count is lower than a second threshold for the transaction class queue (smaller than the first threshold);

Receiving requests and determining their subsequent processing based on the current value of an availability indicator. Subsequent processing may be: (i) creating and scheduling a transaction for immediate execution; (ii) creating and queueing a transaction for execution; or (iii) rejecting the request, without creating a transaction and queuing it for abnormal termination.

An embodiment may be made optional in a processing environment, e.g., through toggling, to provide users with the ability to retain an existing purge mechanism and exact transaction call, if so desired.

The above description provides concepts for request handing in a transaction processing system. These concepts may reduce or avoid a resource overhead associated with of creating specific classes of transaction instances. For instance, embodiments may temporarily reject classes of transaction using an availability indicator that is set based on a count of in-flight requests. In this way, a work item may be rejected when it is likely to abend due to excess queue time.

Accordingly, embodiments may facilitate improved speed and system performance in processing environments. This may improve user/customer service (e.g., better user experience, reduced cost(s), etc.).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

It should now be understood by those of skill in the art, in embodiments of the present invention, the proposed concepts provide numerous advantages over conventional transaction request handling approaches. These advantages include, but are not limited to, reduction of resource overhead associated with of creating specific classes of transaction.

In still further advantages to a technical problem, the systems and processes described herein provide a computer-implemented method for efficient schema generation. In this case, a computer infrastructure, such as the computer system shown in FIGS. 1 and 2 can be provided and one or more systems for performing the processes of the invention can be obtained (e.g., created, purchased, used, modified, etc.) and deployed to the computer infrastructure. To this extent, the deployment of a system can comprise one or more of:
(i) installing program code on a computing device, such as computer system shown in FIG. 2, from a computer-readable medium;
(ii) adding one or more computing devices to the computer infrastructure and more specifically the cloud environment; and
(iii) incorporating and/or modifying one or more existing systems of the computer infrastructure to enable the computer infrastructure to perform the processes of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for determining availability of a transaction in a processing environment, the method comprising:
determining a count value of the number of transactions of a class of transactions existing within the processing environment;
determining the count value meets a first predetermined requirement; and
setting the value of an availability indicator for the class based on the determining the count value meets the first predetermined requirement.

2. The computer-implemented method of claim 1, wherein the count value comprises a smoothed count of the number of transactions of the class existing within the processing environment.

3. The computer-implemented method of claim 2, wherein determining a count value of the number of transactions of the class existing within the processing environment comprises:
calculating the smoothed number of active and queued transactions of the class present within the processing environment.

4. The computer-implemented method of claim 1, wherein the first predetermined requirement requires the count value to be greater than a first threshold value, wherein the first threshold value is greater than a maximum number of active transactions of the class permitted within the processing environment.

5. The computer-implemented method of claim 1, wherein setting the value of the availability indicator for the class comprises:
responsive to determining that the count value meets the first predetermined requirement, setting the value of the availability indicator to indicate that a transaction of the class is not permitted within the processing environment.

6. The computer-implemented method of claim 1, further comprising:
determining the count value meets a second predetermined requirement; and
setting the value of an availability indicator for the class based on whether or not the count value is determined to meet the second predetermined requirement.

7. The computer-implemented method of claim 6, wherein the second predetermined requirement requires the count value to be less than a second threshold value, the second threshold value being less than the first threshold value; and
wherein the second threshold value is less than a maximum number of active transactions of the class permitted within the processing environment.

8. The computer-implemented method of claim 6, wherein setting the value of the availability indicator for the class comprises:
responsive to determining that the count value meets the second predetermined requirement, conditioned upon the value of the availability indicator indicates that a transaction of the class is not permitted within the processing environment, setting the value of the availability indicator to indicate that a transaction of the class is permitted within the processing environment.

9. The computer-implemented method of claim 1, wherein the processing environment comprises a transaction processing environment.

10. The computer-implemented method of claim 1, further comprising:
receiving an inbound request for a transaction in the processing environment, the transaction belonging to the class of transactions, wherein the determining a count value of the number of transactions is in response to the receiving; and
determining a handling action for the received request based on the value of the availability indicator for the class.

11. The computer-implemented method of claim 10, wherein determining a handling action for the received request based on the value of the availability indicator for the class comprises:
conditioned upon the value of the availability indicator for the class indicating that a transaction of the class is not permitted to be executed or queued for execution within the processing environment, determining that the handling action is to reject the received request.

12. The computer-implemented method of claim 10, wherein determining a handling action for the received request based on the value of the availability indicator for the class comprises:
conditioned upon the value of the availability indicator for the class indicating that a transaction of the class is permitted within the processing environment, determining that the handling action is to execute or queue the received request.

13. A system comprising:
one or more processors; and
a memory comprising code stored thereon that, when executed by the processor, determines availability of a transaction in a processing environment, the transaction belonging to a class of transactions, and are configured to cause the processor to:
determine a count value of the number of transactions of the class existing within the processing environment;
determine if the count value meets a first predetermined requirement; and
set the value of an availability indicator for the class based on whether or not the count value is determined to meet the first predetermined requirement.

14. The system of claim 13, wherein the first predetermined requirement requires the count value to be greater than a first threshold value, and preferably wherein the first threshold value is greater than a maximum number of active transactions of class permitted within the processing environment.

15. The system of claim 13, wherein the setting the value of the availability indicator for the class comprises:
responsive to determining that the count value meets the first predetermined requirement, the setting the value of the availability indicator to indicate that a transaction of the class is not permitted within the processing environment.

16. The system of claim 13, wherein the code is further configured to cause the processor to:
determine if the count value meets a second predetermined requirement; and
set the value of an availability indicator for the class based on whether or not the count value is determined to meet the second predetermined requirement.

17. The system of claim 16, wherein the second predetermined requirement requires the count value to be less than a second threshold value, the second threshold value being less than the first threshold value, wherein the second threshold value is less than the maximum number of active transactions of the class permitted within the processing environment.

18. The system of claim 16, wherein setting the value of the availability indicator for the class comprises:
responsive to determining that the count value meets the second predetermined requirement, if the value of the availability indicator indicates that a transaction of the class is not permitted within the processing environment, setting the value of the availability indicator to indicate that a transaction of the class is permitted within the processing environment.

19. The system of claim 13, wherein determining a count value of the number of transactions of the class existing within the processing environment comprises:
calculating the smoothed number of active and queued transactions of the class present within the processing environment.

20. A system comprising
one or more processors; and
a memory comprising code stored thereon that, when executed, performs a method for handling an inbound request for a transaction in a processing environment, the method comprising:
receiving a request for a transaction in the processing environment, the transaction belonging to a class of transactions;
determining a count value of the number of transactions of the class existing within the processing environment;
determining if the count value meets a first predetermined requirement;
setting the value of an availability indicator for the class based on whether or not the count value is determined to meet the first predetermined requirement; and
determining a handling action for the received request based on the value of the availability indicator for the class.
